(19) United States
(12) Patent Application Publication
(10) Pub. No.: US 2017/0108447 A1
(43) Pub. Date: Apr. 20, 2017

(54) DETECTING APPARATUS AND DETECTING METHOD

(71) Applicant: Shenzhen China Star Optoelectronics Technology Co., Ltd., Shenzhen, Guangdong (CN)

(72) Inventor: Zhisheng LIN, Shenzhen, Guangdong (CN)

(21) Appl. No.: 14/008,098

(22) PCT Filed: Jun. 29, 2013
(86) PCT No.: PCT/CN13/78503

§ 371 Date: Sep. 27, 2013

(30) Foreign Application Priority Data
Jun. 18, 2013 (CN) 201310243054.6

(51) Int. Cl. G01N 21/94; G08B 21/18; H04N 5/372; G06F 3/14; G01N 21/88; G06T 7/00

(52) U.S. Cl. CPC G01N 21/94; G01N 21/8806; G06T 7/0004; H04N 5/372; G06F 3/14; G08B 21/18

(57) ABSTRACT

The present invention discloses a detecting apparatus, which comprises a main body, a gantry, a camera, a light emitting unit and a light receiving unit, wherein the camera is movably disposed at the gantry and above the substrate to be detected, the light emitting unit and the light receiving unit are located at the opposite sides of the substrate respectively, the light emitting unit is configured to emit light along the surface of the substrate, the light receiving unit is configured to receive the light from the light emitting unit. The detecting apparatus can detect particles on the surface of substrates quickly and efficiently.

### TECHNICAL FIELD OF THE INVENTION

The present invention pertains to the manufacturing technology of liquid crystal displays, and more particularly relates to a detecting apparatus and a detecting method for detecting particles.

### BACKGROUND OF THE INVENTION

Nowadays, LCD (liquid crystal display) TV, PC, Monitors, flat panel displays are widely used. In the manufacturing of flat panel displays, particles have great adverse effect on the quality of flat panel displays. For example, in the manufacturing process of thin film transistor (TFT), the photoresist are coated on the substrate by a coater. Moreover, to make sure the photoresist are applied evenly on the surface of the substrate, the nozzle of the coater is near to the top surface of the substrate (the distance there-between is about 120 micron). In such situation, if the particle on the surface of the substrate adheres to the nozzle, the nozzle may be damaged.

### SUMMARY OF THE INVENTION

The present invention provides a detecting apparatus to solve the mentioned problem above.

The present invention is realized in such a way that: a detecting apparatus, comprising a main body, a gantry, a camera, a light emitting unit and a light receiving unit, wherein the camera is movably disposed at the gantry and above the substrate to be detected, the light emitting unit and the light receiving unit are located at the opposite sides of the substrate respectively, the light emitting unit is configured to emit light along the surface of the substrate, the light receiving unit is configured to receive the light from the light emitting unit.

According to an embodiment disclosed herein, the light emitting unit is a laser transmitter.

According to another embodiment disclosed herein, the light receiving unit is a CCD image sensor.

According to another embodiment disclosed herein, the detecting apparatus further comprises a lighting unit, the lighting unit is adjacent to the camera.

According to another embodiment disclosed herein, the lighting unit is a LED spot light.

According to another embodiment disclosed herein, the camera is a CCD camera.

According to another embodiment disclosed herein, the detecting apparatus further comprises an actuator and a controller, the actuator serves to actuate the camera, the light emitting unit and the light receiving unit, the controller serves to control the camera, the actuator, the light emitting unit and the light receiving unit.

According to another embodiment disclosed herein, the detecting apparatus further comprises an alarm; the alarm is electrically connected to the controller, such that when the light receiving unit detects particles, the alarm is enabled.

According to another embodiment disclosed herein, the detecting apparatus further comprises a longitudinal rail, a lateral rail and a vertical rail, the longitudinal rail and the vertical rail are provided on the gantry, and the lateral rail is provided on the main body, the gantry is slidably mounted on the lateral rail, and the camera is configured to slide along the longitudinal rail and the vertical rail.

According to another embodiment disclosed herein, the detecting apparatus further comprises a displaying unit, the displaying unit serves to display the image captured by the camera.

According to another embodiment disclosed herein, the displaying unit is a computer.

According to another aspect of the present invention, a detecting method is disclosed, which comprises the steps of: emitting light by a light emitting unit along the surface of the substrate to be detected; receiving the light from the light emitting unit by a light receiving unit and determining whether there is a particle or not based on the signal of the light; and turning on a lighting unit, actuating a camera to take a photo for the substrate, and displaying the captured image by a displaying unit when it is determined that there is a particle.

According to the present invention, the detecting apparatus comprises a main body, a gantry, a camera, a light emitting unit and a light receiving unit, wherein the camera is movably disposed at the gantry and above the substrate to be detected, the light emitting unit and the light receiving unit are located at the opposite sides of the substrate respectively, the light emitting unit is configured to emit light along the surface of the substrate, the light receiving unit is configured to receive the light from the light emitting unit. The detecting apparatus can detect particles on the surface of substrates quickly and efficiently

For more clearly and easily understanding above content of the present invention, the following text will take a preferred embodiment of the present invention with reference to the accompanying drawings for detail description as follows.

### BRIEF DESCRIPTION OF THE DRAWINGS

The drawings described herein are for illustration purposes only and are not intended to limit the scope of the present disclosure in any way.

FIG. 1 is a schematic front view of the detecting apparatus according to an embodiment of the present invention;

FIG. 2 is a schematic side view of the detecting apparatus in FIG. 1;

FIG. 3 is the schematic electrical control diagram of the detecting apparatus in FIG. 1; and

FIG. 4 is a schematic flow chart of the detecting method according to an embodiment of the present invention.

### DETAILED DESCRIPTION OF PREFERRED EMBODIMENTS

The following detailed description of every embodiment with reference to the accompanying drawings is used to exemplify a specific embodiment, which may be carried out in the present invention. Directional terms mentioned in the present invention, such as “top”, “bottom”, “front”, “rear”, “left”, “right”, “up”, “down”, “inside”, “outside”, “side” etc., are only used with reference to the orientation of the accompanying drawings. Therefore, the used directional terms are intended to illustrate, but not to limit, the present invention. Also the following description is merely exemplary in nature and is not intended to limit the present disclosure, application, or uses. Besides, the term “a particle” and “particles” used herein included foreign matters not belonging naturally in the place where found.

The detecting apparatus and detecting method according to the present invention may be used to detect particles on the surface of substrates 100 in the manufacturing process of thin film transistor (TFT), such that the nozzle of the coater will not be scraped and thus damaged by particles. The particles may be all kinds of solid particles such as dust.

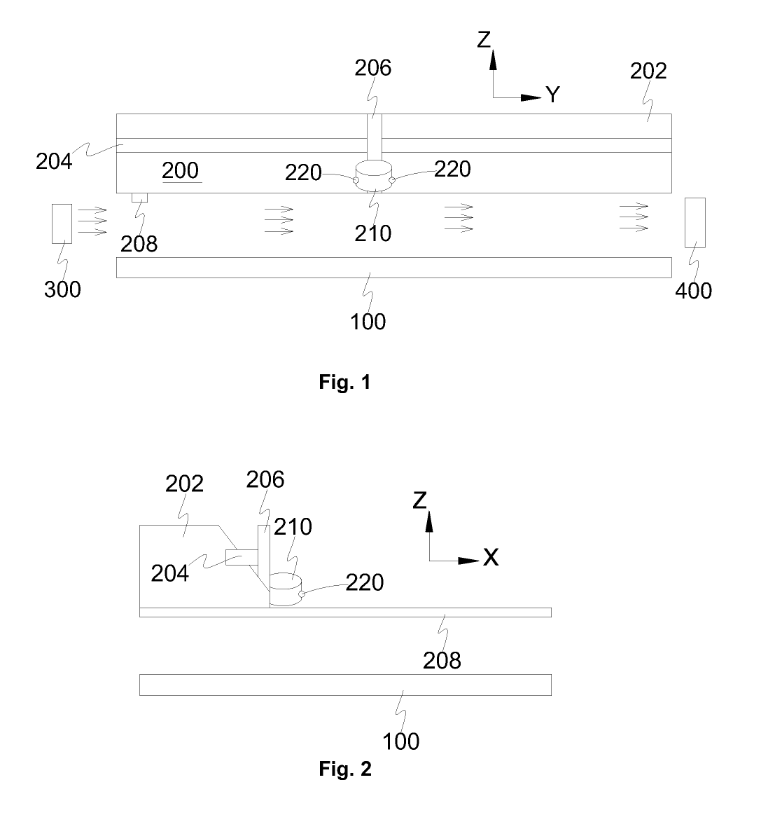

As shown in FIG. 1 and FIG. 2, the detecting apparatus comprises a main body 200, a gantry 202, a camera 210, a light emitting unit 300 and a light receiving unit 400. The camera 210 is movably disposed at the gantry 202. The camera 210 is above the substrate 100 to be detected so as to take a photo for the substrate 100 when necessary. The light emitting unit 300 and the light receiving unit 400 are located at the opposite sides of the substrate 100 respectively. The light emitting unit 300 is configured to emit light along the surface of the substrate 100; the light receiving unit 400 is configured to receive the light emitted from the light emitting unit 300 correspondingly. When the light receiving unit 400 is shaded from the light by particles completely or partly, it is considered that the particles is detected. When the light receiving unit 400 is not shaded from the light by particles, it is considered that there is no particle. In this way, on the basis of shading degree, the existence and the size (including height and width) of particles can be deduced. The light emitting unit 300 may be laser transmitter; while the light receiving unit 400 may be CCD (charge-coupled device) image sensor. In one embodiment, the light receiving unit 400 (CCD image sensor) can convert the light emitted by the light emitting unit 300 into digital voltage value.

In the embodiment shown in FIG. 1 through FIG. 3, the detecting apparatus further comprises a lighting unit 220. The lighting unit 220 is adjacent to the camera 210. The lighting unit 220 may include at least one LED spot light. The camera 210 may be a CCD (charge-coupled device) camera. By means of the lighting unit 220, the camera 210 can take a clear photo for the substrate 100 and it is easy to find particles quickly if there is particles.

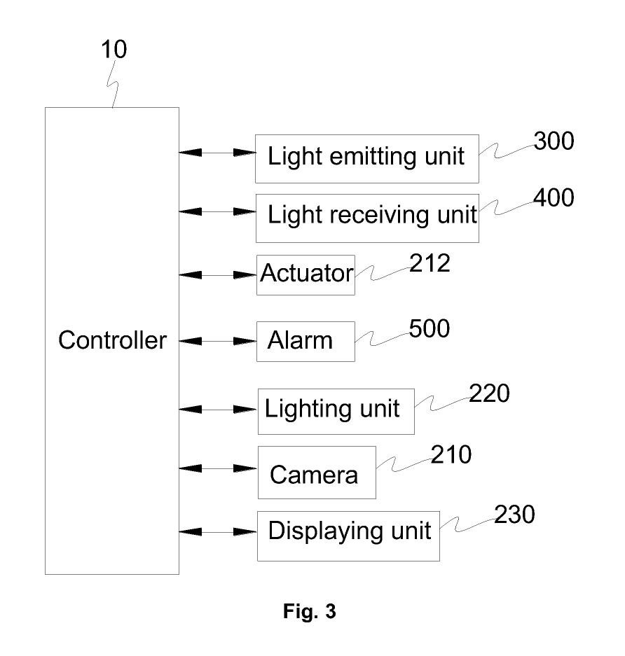

In one embodiment, the detecting apparatus further comprises an actuator 212 and a controller 10. As shown in FIG. 3, the actuator 212 serves to actuate the camera 210, the light emitting unit 300 and the light receiving unit 400 to move as needed, the controller 10 serves to control the camera 210, the actuator 212, the light emitting unit 300 and the light receiving unit 400. In detection, the glass substrate 100 may be stationary, while the light emitting unit 300 may scan on the glass substrate 100 quickly along the longitudinal direction Y or lateral direction X. In this embodiment, the light emitting unit 300 may scan on the glass substrate 100 quickly along the lateral direction X.

Moreover, the detecting apparatus further comprise an alarm 500 as shown in FIG. 3. The alarm 500 is electrically connected to the controller 10, such that when the light receiving unit 400 detects particles, the alarm 500 is enabled. The alarm 500 serves to warn of danger by means of a sound or signal.

In the embodiment shown in FIG. 1 and FIG. 2, the detecting apparatus further comprises a longitudinal rail 204, a lateral rail 208 and a vertical rail 206. The longitudinal rail 204 and the vertical rail 206 are provided on the gantry 202, and the lateral rail 208 is provided on the main body 200. The longitudinal rail 204 extends along the longitudinal direction Y. The lateral rail 208 extends along the lateral direction X. The vertical rail 206 extends along the vertical direction Z. The gantry 202 is slidably mounted on the lateral rail 208. In other words, the gantry 202 can slide along the lateral rail 208 by the actuator 212. The camera 210 is configured to slide along the longitudinal rail 204 and the vertical rail 206. The camera 210 may slide along the longitudinal rail 204 and the vertical rail 206 freely by the actuator 212. The actuator 212 drives the gantry 202 and the camera 210, such that the gantry 202 and the camera 210 slide along respective rails.

In this embodiment, the detecting apparatus further comprises a displaying unit 230. The displaying unit 230 serves to display the image captured by the camera 210. The displaying unit 230 may be a computer. In such way, the controller 10 can be integrated into the displaying unit 230.

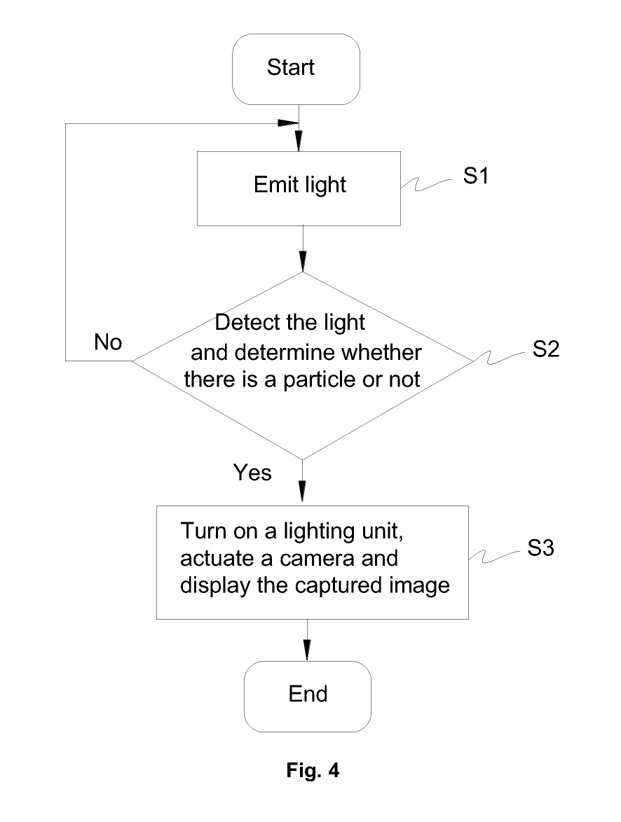

As shown in FIG. 4, the present invention further provides a detecting method using the detecting apparatus described above. The detecting method comprises an emitting light step S1, a detecting step S2, and a displaying step S3. In the emitting light step S1, a light emitting unit emits light along the surface of the substrate to be detected. In the detecting step S2, a light receiving unit receives the light emitted from the light emitting unit and determine whether there is a particle or not based on the digital signal of the light. In displaying step S3, a lighting unit is turned on, a camera is actuated to move to take a photo for the substrate, and a displaying unit displays the captured image when it is determined that there is a particle. Moreover, when it is determined that there is a particle, an alarm can be enabled to notify operators to handle and remove the particles according to related procedures. In a preferred embodiment of the detecting method, the light emitting unit is a laser transmitter; the light receiving unit is a CCD image sensor; the lighting unit is a LED spot light; and the camera is a CCD camera.

In the detecting apparatus and the detecting method described above, when the scanning light is emitted from the light emitting unit, the light receiving unit will only receive a part of light if there is any particles on the substrate. The digital signal of the light intensity can be analyzed by the light receiving unit and the controller, thus the size of the particles can be calculated. The light receiving unit (CCD image sensor) can convert the light emitted by the light emitting unit into digital value. Also the light receiving unit (CCD image sensor) may divide the light emitted by the light emitting unit into several square-shaped areas along the vertical direction Z and the longitudinal direction Y. Furthermore, the effective width of detection of the light receiving unit can be set and changed as needed, so as to detect different kinds of particles.

According to the detecting apparatus and the detecting method described above, when there is any particles on the substrate, the gantry and the camera will be driven to move along their respective rails in the control of controller, meanwhile the lighting unit will be turned on. In this way, the position (coordinates) of the particles can be found quickly and efficiently. Also, the displaying unit is used to display the captured image of the camera. The camera may have a zooming function. Therefore, it is convenient to observe the particles for operators. Also, operators can find out the particles without entering the booth.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A detecting apparatus, comprising a main body, a gantry, a camera, a light emitting unit and a light receiving unit, wherein the camera is movably disposed at the gantry and above the substrate to be detected, the light emitting unit and the light receiving unit are located at the opposite sides of the substrate respectively, the light emitting unit is configured to emit light along the surface of the substrate, the light receiving unit is configured to receive the light from the light emitting unit.

2. The detecting apparatus of claim 1, wherein the light emitting unit is a laser transmitter.

3. The detecting apparatus of claim 1, wherein the light receiving unit is a CCD image sensor.

4. The detecting apparatus of claim 1, wherein the detecting apparatus further comprises a lighting unit, the lighting unit is adjacent to the camera.

5. The detecting apparatus of claim 4, wherein the lighting unit is a LED spot light.

6. The detecting apparatus of claim 1, wherein the camera is a CCD camera.

7. The detecting apparatus of claim 1, wherein the detecting apparatus further comprises an actuator and a controller, the actuator serves to actuate the camera, the light emitting unit and the light receiving unit, the controller serves to control the camera, the actuator, the light emitting unit and the light receiving unit.

8. The detecting apparatus of claim 7, wherein the detecting apparatus further comprises an alarm; the alarm is electrically connected to the controller, such that when the light receiving unit detects particles, the alarm is enabled.

9. The detecting apparatus of claim 7, wherein the detecting apparatus further comprises a longitudinal rail, a lateral rail and a vertical rail, the longitudinal rail and the vertical rail are provided on the gantry, and the lateral rail is provided on the main body, the gantry is slidably mounted on the lateral rail, and the camera is configured to slide along the longitudinal rail and the vertical rail.

10. The detecting apparatus of claim 7, wherein the detecting apparatus further comprises a displaying unit, the displaying unit serves to display the image captured by the camera.

11. The detecting apparatus of claim 10, wherein the displaying unit is a computer.

12. A detecting method, comprising the steps of: emitting light by a light emitting unit along the surface of the substrate to be detected; receiving the light from the light emitting unit by a light receiving unit and determining whether there is a particle or not based on the signal of the light; and turning on a lighting unit, actuating a camera to take a photo for the substrate, and displaying the captured image by a displaying unit when it is determined that there is a particle.

13. The detecting method of claim 12, wherein the light emitting unit is a laser transmitter.

14. The detecting method of claim 12, wherein the light receiving unit is a CCD image sensor.

15. The detecting method of claim 12, wherein the lighting unit is a LED spot light.

16. The detecting method of claim 12, wherein the camera is a CCD camera.
